(19) United States
(12) Patent Application Publication
(10) Pub. No.: US 2025/0151004 A1
(43) Pub. Date: May 8, 2025

(54) ELECTRONIC DEVICE AND CONTROLLING METHOD THEREOF

(71) Applicant: SAMSUNG ELECTRONICS CO., LTD., Suwon-si (KR)

(72) Inventor: Seongil HAHM, Suwon-si (KR)

(73) Assignee: SAMSUNG ELECTRONICS CO., LTD., Suwon-si (KR)

(21) Appl. No.: 19/016,685

(22) Filed: Jan. 10, 2025

Related U.S. Application Data
(63) Continuation of application No. PCT/KR2023/008097, filed on Jun. 13, 2023.

(30) Foreign Application Priority Data
Aug. 11, 2022 (KR) 10-2022-0100636

(51) Int. Cl. H04W 60/04; G16Y 40/35; H04L 67/12

(52) U.S. Cl. CPC H04W 60/04; G16Y 40/35; H04L 67/12

(57) ABSTRACT

An electronic device includes: memory storing location information of the electronic device and reference information associated with each of a plurality of locations; and at least one processor configured to: based on device information of an unregistered Internet of Things (IoT) device being received through the communication device, set the IoT device as an available IoT device by: identifying a product type of the IoT device based on the device information, predicting a location of the IoT device based on the product type, identifying a signal strength reference value associated with the IoT device based on the reference information, a location of the electronic device, and the location of the IoT device, and identifying whether the IoT device is the available IoT device based on a comparison of the signal strength reference value associated with the IoT device with a signal strength of the IoT device.

### CROSS-REFERENCES TO RELATED APPLICATIONS

The present application is a continuation of International Application No. PCT/KR2023/008097, filed on Jun. 13, 2023, with the Korean Intellectual Property Office, which claims priority to Korean Patent Application No. 10-2022-0100636, filed on Aug. 11, 2022, with the Korean Intellectual Property Office, the disclosures of which are incorporated herein in their entireties by reference.

### BACKGROUND

### 1. Field

The present disclosure relates to an electronic device and a controlling method thereof, and more particularly to, an electronic device capable of determining whether a new IoT device requires registration based on location information corresponding to the type of the new IoT device and measured signal strength.

### 2. Description of Related Art

The Internet of Things (IoT) is an intelligent technology and service that connects all things based on the Internet to interact and communicate information. In recent years, various types of IoT devices have been developed and are rapidly being distributed to homes and businesses.

In order to use these IoT devices, users had to register a new IoT device with a service (or server), or set the IoT device to be able to connect to the Internet, etc.

### SUMMARY

According to an aspect of the disclosure, an electronic device includes: a communication device; memory storing location information of the electronic device and reference information associated with each of a plurality of locations; and at least one processor configured to, based on device information of an unregistered Internet of Things (IoT) device being received through the communication device, set the IoT device as an available IoT device, wherein the at least one processor is further configured to set the IoT device as the available IoT device by: identifying a product type of the IoT device based on the device information, predicting a location of the IoT device based on the product type, identifying a signal strength reference value associated with the IoT device based on the reference information associated with each of the plurality of locations, a location of the electronic device, and the location of the IoT device, and identifying whether the IoT device is the available IoT device based on a comparison of the signal strength reference value associated with the IoT device with a signal strength of the IoT device.

The at least one processor may be further configured to, based on the signal strength of the IoT device being less than the signal strength reference value associated with the IoT device, identify the IoT device as an unavailable IoT device.

The signal strength reference value associated with the IoT device may include a lower threshold reference value and an upper threshold reference value; and the at least one processor may be further configured to: based on the signal strength of the IoT device being between the upper threshold reference value and the lower threshold reference value, identify the IoT device as the available IoT device, and based on the signal strength of the IoT device being greater than the upper threshold reference value or less than the lower threshold reference value, identify the IoT device as an unavailable IoT device.

The at least one processor may be further configured to: predict a plurality of possible locations of the IoT device based on the product type, and identify whether the IoT device is the available IoT device based on a comparison of a signal strength reference value corresponding to each of the plurality of locations with the signal strength of the IoT device.

The reference information associated with each of the plurality of locations stored in the memory is information generated based on a type of living space where the electronic device is located and a size of the living space.

The communication device is configured to identify the location of the electronic device based on a signal strength of a signal received from a pre-registered IoT device, and to store the location of the electronic device in the memory.

The electronic device may further include a display, and the at least one processor may be further configured to, based on the IoT device being the available IoT device, control the display to display that setting registration of the IoT device is possible.

The at least one processor may be further configured to, based on the IoT device being the available IoT device, control the communication device to transmit information indicating that setting registration of the IoT device is possible to at least one of a pre-registered IoT device or a pre-registered user terminal device.

The at least one processor may be further configured to, based on the IoT device being set as the available IoT device, control the communication device to transmit to the IoT device at least one of information required for connecting to Internet or information required for connecting to an IoT server.

The at least one processor may be further configured to, based on receiving, from each pre-registered IoT device, information about respective signal strength between other IoT devices measured by the pre-registered IoT device, update the reference information associated with each of the plurality of locations in accordance with the received information about the respective signal strength and location information of the pre-registered IoT device.

According to an aspect of the disclosure, a controlling method of an electronic device, includes: receiving device information of an unregistered IoT device; identifying whether the Internet of Things (IoT) device is an available IoT device; and based on the IoT device being the available IoT device, setting the IoT device as the available IoT device, wherein the identifying whether the IoT device is the available IoT device includes: identifying a product type of the IoT device based on the device information; predicting a location of the IoT device based on the product type; identifying a signal strength reference value associated with the IoT device based on pre-stored reference information associated with each of a plurality of locations, a location of the electronic device and the location of the IoT device; and identifying whether the IoT device is the available IoT device based on a comparison of the signal strength reference value associated with the IoT device with a signal strength of the IoT device.

The identifying whether the IoT device is the available IoT device may include, based on the signal strength of the IoT device being less than the signal strength reference value associated with the IoT device, identify the IoT device as an unavailable IoT device.

The signal strength reference value associated with the IoT device may include a lower threshold reference value and an upper threshold reference value; and the identifying whether the IoT device is the available IoT device may include: based on the signal strength of the IoT device being between the upper threshold reference value and the lower threshold reference value, identifying the IoT device as the available IoT device, and based on the signal strength of the IoT device being greater than the upper threshold reference value or less than the lower threshold reference value, identifying the IoT device as an unavailable IoT device.

The predicting the location of the IoT device may include predicting a plurality of possible locations of the IoT device based on the product type; and the identifying whether the IoT device is the available IoT device may further include identifying whether the IoT device is the available IoT device based on a comparison of a signal strength reference value corresponding to each of the plurality of locations with the signal strength of the IoT device.

The method may further include: receiving, from each pre-registered IoT device, information about respective signal strength between other IoT devices measured by the pre-registered IoT device; and updating the reference information associated with each of the plurality of locations based on the received information about the respective signal strength and location information of the pre-registered IoT device.

### BRIEF DESCRIPTION OF DRAWINGS

The above and other aspects, features and advantages of the embodiments of the present disclosure will become more apparent from the following description with reference to the accompanying drawings, in which:

FIG. 1 is a view illustrating an electronic system according to an embodiment;

FIG. 2 is a block diagram illustrating configuration of an electronic device according to an embodiment;

FIG. 3 is a sequence view provided to explain a registration process of a new electronic device according to an embodiment;

FIG. 4 is a sequence view provided to explain a registration process of a new electronic device according to an embodiment;

FIG. 5 is a view illustrating another application environment of the present disclosure;

FIG. 6 is a view illustrating an example of a lookup table according to an embodiment; and

FIG. 7 is a flowchart provided to explain a control operation of an electronic device according to an embodiment.

### DETAILED DESCRIPTION

Hereinafter, various embodiments of the present disclosure will be described with reference to the accompanying drawings. However, it is to be understood that the disclosure is not limited to specific exemplary embodiments, but include all modifications, equivalents, and/or alternatives according to exemplary embodiments of the disclosure. Throughout the description of the accompanying drawings, similar components may be denoted by similar reference numerals.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element). On the other hand, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware. Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

Hereinafter, the present disclosure will be described with reference to the accompanying drawings.

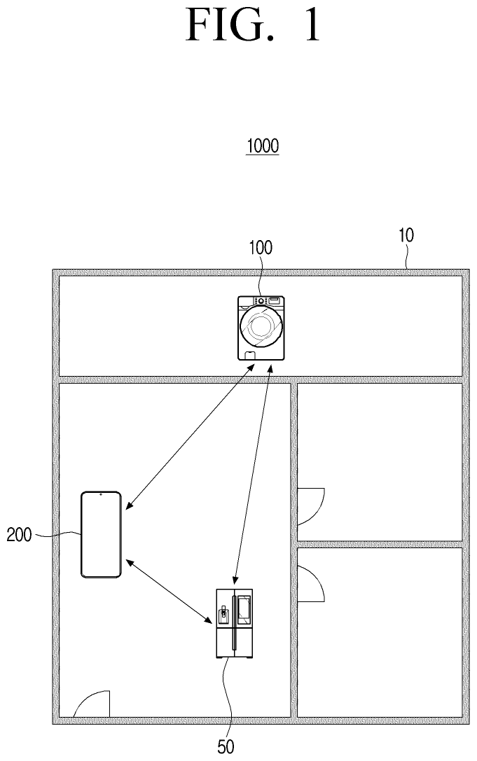

FIG. 1 is a view illustrating an electronic system according to an embodiment.

Referring to FIG. 1, an IoT system 1000 includes a plurality of IoT devices (e.g., IoT device 100, IoT device 200). While it is illustrated that the IoT system 1000 includes only two IoT devices—IoT device 100 and IoT device 200—in an implementation, the IoT system may include only one IoT device, or may include three or more IoT devices.

In addition, the IoT system 1000 may include an IoT server for managing a plurality of IoT devices, and the IoT server may be located in the same space where the plurality of IoT devices are located, or may be located in an external space spaced apart from the plurality of IoT devices. Further, any one of the IoT devices may serve as the IoT server.

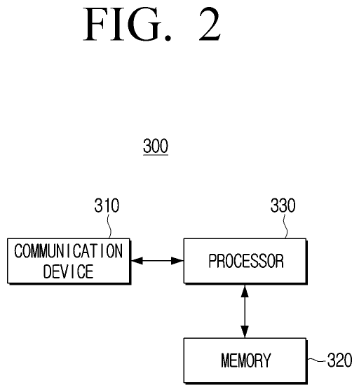

Each of the plurality of IoT devices (e.g., IoT device 100, IoT device 200) may be connected to an IoT system to perform a function supported by each device. In addition, each of the plurality of IoT devices (e.g., IoT device 100, IoT device 200) may transmit and receive information and control commands necessary for performing each function with other IoT devices. The specific configuration and operation of these IoT devices will be described later with reference to FIG. 2.

As described above, the plurality of IoT devices (e.g., IoT device 100, IoT device 200) may be located in a specific space. Such a space may be a residence where a user lives, a work facility, a public institution, or any other space. Hereinafter, for convenience of explanation, it is assumed that the space is a living space (e.g., living space 10), but an implementation may be applicable to various environments such as an office, a public office, etc.

When a new IoT device 50 is located (or installed) in a user's living space 10 as described above, the installed IoT device is not registered with the IoT system 1000. Therefore, registration with the IoT system 1000 or access to the Internet network is required to run the services of the IoT device 50.

If the new IoT device is a device capable of receiving various information such as display, touch, etc., it is possible to connect the new IoT device to the IoT system or the Internet environment by entering various settings for connection to the IoT system in the corresponding new IoT device.

However, if the function for receiving various settings required for connection to the IoT system is not equipped, connection to the IoT system or the Internet environment must be conducted with the help of other devices. For this function, each device in the IoT system may support functions such as easy setup, onboarding, commissioning, etc. These functions may be referred to by expressions other than those described above, and the corresponding function is the function of the IoT device connecting to the IoT system or the Internet network with the help of other devices.

For such an operation, the new IoT device may transmit a beacon to the surroundings, other IoT devices that receive the beacon may notify the user that there is a new IoT device that can be connected to a user terminal device or directly, and the user can register the new IoT device through the notification.

This approach is highly convenient in that it allows the user to easily register a new IoT device with the IoT environment. However, if the notification is sent for a device that is not a device installed by the user or a device that is not a new device installed in the user's space, the user will receive an unnecessary notification, which may cause inconvenience.

For example, if a new IoT device is installed in a neighbor's house, and the new IoT device is detected by an IoT device located in the user's space and indicated as available for installation, the user will receive an unnecessary notification.

As such, even if a new IoT device is detected on a user terminal device or a pre-registered IoT device, it is necessary to notify the user only of a new IoT device that meets certain criteria rather than unconditionally notifying the user that a new IoT device has been detected.

For this operation, the present disclosure may, when a new IoT device is detected, identify whether the new IoT device is an IoT device available to the user, and perform notification and/or setup operations for the new IoT device only when the new IoT device is an available IoT device.

Hereinafter, a specific method of identifying whether a new IoT device is an available IoT device will be described.

When a user terminal device or a pre-registered IoT device and a new IoT device are located close to each other in the same space, the signal strength will be very high. Therefore, the signal strength between the new IoT device and other IoT devices may be used to identify whether the new IoT device is an available IoT device.

For example, when a new IoT device has signal strength corresponding to a distance of 1˜2 meters from a user terminal device or a pre-registered IoT device, it is possible to identify whether the new IoT device is an available device using only the method described above.

However, the environment in which users live is often larger than the space range of 1˜2 meters, and in a living space such as a typical apartment, the distance can be as much as 5˜10 meters. Therefore, identifying whether a new IoT device is an available IoT device simply by the signal strength may be inaccurate.

For example, in a space like an apartment, the distance between the veranda and the utility room may be greater than the distance between the utility room and the utility room of the neighboring house. In addition, in a living space such as a studio apartment or an office building, the distance between neighboring houses may be very short. As such, it is not accurate to identify whether an IoT device is an available IoT device based only on the distance or the signal strength corresponding to the distance depending on the living environment.

Accordingly, when a new IoT device is detected, the present disclosure identifies the type of the corresponding IoT device, predicts a space (or location) where the corresponding IoT device will be located based on the identified type of product, and identifies whether the IoT device is an available IoT device by comparing a reference signal value between the predicted space and the location of a pre-registered IoT device with a measured signal value.

For example, as illustrated in FIG. 1, if a refrigerator is newly installed in the user's living space 10, the pre-established IoT devices (e.g., IoT device 100, IoT device 200) may receive a beacon transmitted from the new IoT device 50, and identify that there is a new IoT device.

For convenience of explanation, it is assumed that the first IoT device 100 detects the beacon of the new IoT device 50. Upon receiving the beacon, the first IoT device 100 may receive device information from the new IoT device 50, and may use the device information to identify that the new IoT device 50 is a refrigerator. As a refrigerator is commonly installed in a kitchen, the first IoT device may predict that the new IoT device is installed in a kitchen. This location prediction is one example, and in an implementation, one or more predicted locations per device type may be stored in the form of a lookup table, and the location of a new IoT device detected may be predicted using the stored lookup table.

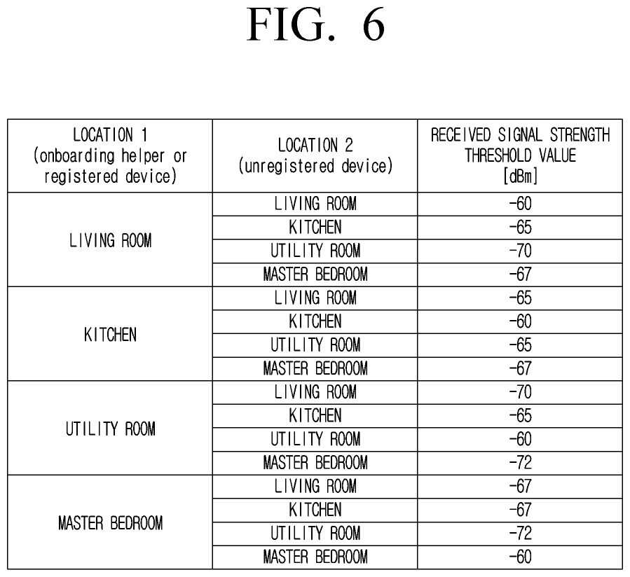

Subsequently, by comparing a signal strength reference value between the utility room and the kitchen where the first IoT device 100 is located with an actual measured signal value, it is possible to verify whether the new IoT device is installed in the kitchen. The signal strength reference value between a plurality of spaces may be stored in the form of a lookup table, and the lookup table used in the present disclosure will be described later with reference to FIG. 6.

When it is identified that the actual measured signal strength is within the range of the reference strength between the utility room and the kitchen, the first IoT device 100 may identify that the new IoT device has been installed (or located) in the user space, and may proceed with a series of steps to register the new IoT device with the IoT system.

Here, the strength of the signal may be measured using Received signal Strength Indicator (RSSI) value and various other measurements used to identify various signal levels and quality such as Reference Signals Received Power (RSRP), Reference Signal Received Quality (RSRQ), and the like.

When it is identified that the first IoT device 100 is not within a reference strength range between the utility room and the kitchen, the first IoT device 100 may not proceed with the process for registering the corresponding device (e.g., notifying the user that the new IoT registration is possible)

For example, when a refrigerator is newly installed in a neighbor's kitchen, one of the user's IoT devices located adjacent to the neighbor's kitchen (hereinafter, the user device) may detect the corresponding refrigerator. However, the signal strength between the neighbor's kitchen and the location of the user device would be different from the signal strength between the user's kitchen space and the location of the user device, so the first IoT device 100 may identify that the neighbor's new IoT device is not an available IoT device.

Such a registration process is only one example according to the present disclosure, and may be implemented in addition to other processes not described in the example operations described above, or in a form that omits some of the operations described above.

As described above, the IoT system according to an embodiment predicts the location of an unregistered IoT device, and considers the signal strength by taking into account the current location of the electronic device and the predicted location of the IoT device, making it possible to identify whether the corresponding IoT device is an available device to the user more accurately.

Although FIG. 1 shows and describes that there is only one IoT system in an environment, a plurality of IoT systems may exist in an environment, and it is also possible that a plurality of IoT systems operate in conjunction with each other. For example, one IoT device may be included in each of a plurality of IoT systems.

FIG. 2 is a block diagram illustrating configuration of an electronic device according to an embodiment.

Referring to FIG. 2, an electronic device 300 includes a communication device 310, memory 320, and at least one processor 330. Here, the electronic device 300 may be various IoT devices (e.g., various sensors, IP cameras, home appliances (e.g., refrigerators, washing machines, ovens, vacuum cleaners, air conditioners, air purifiers, etc.)) or user terminals (e.g., smartphones, tablets, laptops, etc.) that can be connected to IoT devices. In other words, the IoT devices (e.g., IoT device 100, IoT device 200) shown in FIG. 1 may be the electronic devices of FIG. 2. Although user terminal devices are described here as distinct from IoT devices, user terminal devices may also be IoT devices.

The communication device 310 may perform communication with external electronic devices. To this end, the communication device 310 may include various communication modules to perform communication with external devices. In one example, the communication device 310 may include a wireless communication module, such as a cellular communication module using at least one of LTE, LTE Advance (LTE-A), code division multiple access (CDMA), wideband CDMA (WCDMA), universal mobile telecommunications system (UMTS), wireless broadband (WiBro), or global system for mobile communications (GSM). In another example, the wireless communication module may include at least one of, for example, wireless fidelity (WiFi), Bluetooth, Bluetooth low energy (BLE), Zigbee, near field communication (NFC), magnetic secure transmission, radio frequency (RF), or body area network (BAN). In addition, a communication interface 120 may include a wired communication module. For example, the communication interface120 may include at least one of universal serial bus (USB), high definition multimedia interface (HDMI), recommended standard 232 (RS-232), power line communication, or plain old telephone service (POTS). The network over which the wireless or wired communication is performed may include a telecommunications network, for example, at least one of a computer network (e.g., LAN or WAN), the Internet, or a telephone network.

The communication device 310 may transmit a beacon that transmits a signal to an external device, and may receive a beacon transmitted from another device. Here, the beacon may be a beacon indicating a new IoT device, or a beacon indicating that an Internet connection is required, or a beacon indicating that registration with an IoT system is required, etc.

The communication device 310 may also receive device information from other devices, or transmit and receive various information (e.g., serial number, product type, setup ID, network key, GSSID, SSID, pass phrase, algorithm, etc.) for registration of other devices into the IT system. For example, when the electronic device 300 is a new IoT device of FIG. 1, the communication device 310 may connect to an Internet network and/or connect to an IoT system based on the information received. The communication device may also perform a P2P communication connection with another electronic device for transmission of the above-described information.

When the electronic device 300 is not a user terminal device or the like, the communication device 310 may transmit information indicating that a new IoT device has been detected to the user terminal device or another IoT device.

Subsequently, the communication device 310 may measure the strength value of the signal transmitted from the new IoT device. Here, the strength value may be any of a variety of measurement values such as RSSI, RSRP, RSRQ, or any combination of the aforementioned measurement values.

The memory 320 may store instructions or data associated with at least one other component of the electronic device 300. In particular, memory 320 may be implemented as non-volatile memory, volatile memory, flash-memory, hard disk drive (HDD), or solid state drive (SSD). The memory 320 may be accessed by the processor 140, and the data may be read/written/modified/deleted/updated by the processor 330. The term ‘memory’ used herein may include the memory 320, a ROM within the processor 330, RAM, or a memory card (e.g., micro SD card, memory stick) mounted in the electronic device 300. In addition, the memory 320 may store programs and data, etc. for configuring various screens to be displayed on the display area of the display.

The memory 320 stores location information of the electronic device 300. Here, the location information means information about the space in the user's space in which the electronic device is currently located. For example, in the case of a refrigerator, the location information may be the kitchen in which the refrigerator is located (or an identification number corresponding to the kitchen). This location may be information that was entered by the user during the installation process of the electronic device.

In this case, the memory 320 may store map information corresponding to the user's living space, and may store a location (e.g., coordinates) on the map information as location information. For example, when a device such as a robot cleaner is located in the IoT system, the robot cleaner may generate map information of the living space, and may identify the location of various objects within each map. Accordingly, when the IoT system includes a robot cleaner, it is possible to use the map information generated by the robot cleaner. In an implementation, it is possible for the IoT device not only to generate map information, but also to receive and use map information about a living space corresponding to an address from a server based on address information entered by the user.

Alternatively, when the electronic device 300 is a mobile device, the location information of an IoT device with the strongest signal strength may be received by transmitting and receiving signals between the currently pre-registered IoT devices, which may be the location information received from the corresponding IoT device.

For example, when a device such as a refrigerator, TV, or the like is a pre-registered IoT device and the current electronic device is a user terminal device, and if the signal strength received from the refrigerator is the strongest, the electronic device 300 is likely to be located in a space where the refrigerator is located (e.g., a kitchen). Accordingly, the memory 320 may store the location information received from the refrigerator in the memory 320. In an implementation, the signal strength between each of a plurality of devices may be measured, and the location of the electronic device 300 may be calculated and stored by, for example, triangulating the measured signal strength and the location of each device.

Subsequently, the memory 320 stores reference information for each of a plurality of locations. Here, the plurality of locations may be information about separated spaces regarding the user space, for example, a living room, a bedroom, a kitchen, a utility room, etc. This space information may be automatically generated based on the living environment entered by the user, or may be designated by a space name directly entered by the user. The reference information for each space may be information initially provided by an external server, or may be a value updated by an actual measured signal value. This reference information may be stored in the form of a lookup table. This reference information may be stored in the form of a lookup table.

The processor 330 may be electrically connected to the memory 320 to control the overall operations and functions the electronic device 300. Specifically, the processor 330 may perform a function corresponding to the electronic device 300 based on instructions stored in the memory 320. For example, when the electronic device 300 is a refrigerator, the processor 330 may perform a function corresponding to the refrigerator.

When a preset period or a preset event (e.g., a command to search for an IoT device from an external device) occurs during a normal operation, the processor 330 may search for the presence of a new IoT device.

When the new IoT device 50 is detected during such a search process, the processor 330 may control the communication device 310 to receive device information of the new IoT device 50. For example, when the beacon transmitted from the new IoT device 50 includes device information, the processor 330 may identify the device information from the corresponding beacon information. When the beacon information does not include device information, the electronic device 300 may control the communication device 310 to establish a connection with the new IoT device and receive the device information of the new IoT device through communication with corresponding the device.

For example, when the new IoT device supports a WiFi method, the processor 330 may control the communication device 310 to perform a connection with the new IoT device in a WiFi Direct method, may receive device information through the corresponding communication method, and may control the communication device 310 to measure a signal strength value in the process of receiving the corresponding device information. Alternatively, when the new IoT device supports a BLE method, the processor 330 may control the communication device 310 to perform a connection with the new IoT device in the BLE method, and may receive device information through the corresponding communication method.

When the device information of the new IoT device 50 is received, the processor 330 may identify the device type of the new IoT device based on the received device information. Specifically, when the device information includes information about the device type, the processor 330 may identify the included device type as the device type of the new IoT device. When the received device information does not include information about the device type, the processor 330 may transmit other information included in the device information to an external server, and identify information about the device type provided by the external server as the device information for the new IoT device.

Once the device type is identified, the processor 330 may predict a location corresponding to the identified device type. To this end, the memory 320 may store a lookup table with device types and corresponding location information. In this case, the processor 330 may predict a location where the new IoT device is likely to be located using the lookup table. When a separate lookup table is not stored, the processor 330 may receive and use a predicted location from an external server. In this case, the processor 330 may control the communication device 310 to transmit the pre-stored reference information for each of a plurality of locations together to the external server for accurate prediction. In an implementation, the processor 330 may predict only one location for a new IoT device, or may predict a plurality of locations. Further, in the case of predicting a plurality of locations, each predicted location may be prioritized.

Once the location of the new IoT device is predicted, the processor 330 may identify a strength reference value corresponding to the predicted location of the new IoT device and the location of the electronic device from the reference information for each of the plurality of locations stored in the memory 320. Such a reference value may have only a lower limit value, or may include limit and upper limit values. In an implementation, the reference value may have an average value (or predicted signal strength value), and the processor 330 may also calculate and use an upper limit threshold value and a lower limit threshold value by using a certain value based on the corresponding reference value.

Once the signal strength threshold is identified, the processor 330 may compare the actual measured signal strength of the IoT device with the identified signal strength reference value to identify whether the new IoT device is an available device. For example, when the measured signal value is greater than the signal strength reference value, the new IoT device can be identified as an available device.

Conversely, when the measured signal value is less than the signal strength reference value, the processor 330 may identify the new IoT device as an unavailable device. When the signal strength reference value consists of lower and upper limits, the processor 330 may identify whether the new IoT device is an available device based on whether the measured signal value falls within the range consisting of the lower and upper limits.

In this case, the processor 330 may control the communication device 310 to receive information about the signal strength from other IoT devices to the corresponding new IoT device, and may identify whether the new IoT device is an available device by considering the signal strength between the electronic device 300 and the new IoT device and the signal strength between the other IoT devices and the new IoT device together. For example, the location of the new IoT device may be predicted by triangulating or the like using the signal strengths between the three devices described above, and whether the new IoT device is an available device may be identified by comparing the location predicted by the calculation with the location predicted by the device information above.

In addition, the processor 330 may use a separate threshold value in addition to the strength reference value described above. Here, the separate threshold value may be a maximum threshold value and/or a minimum threshold value. For example, the maximum threshold vale may be a signal strength value when two devices are located in close proximity, such as 1 to 2 meters, and when the corresponding signal strength value is detected, the processor 330 may identify that the new IoT device is an available IoT device, without the operation of predicting the location of the new IoT device. The minimum threshold value is a signal value that is less than the signal strength measured at a maximum distance within the user space, so regarding an IoT device with a signal strength that is less than the minimum threshold value, it may not be identified whether an IoT device is an available device.

As such, when it is identified that the new IoT device is an available device, the processor 330 may perform the process of registering the corresponding IoT device. For example, when the electronic device 300 includes a display, the processor 330 may control the display to display information that the new IoT has been detected and is available for registration. When the electronic device 300 does not include a display, the processor 330 may control the communication device 310 to transmit the corresponding information such that a notification confirming whether to register is displayed in the pre-registered user terminal device or other pre-registered IoT devices.

Here, whether a display is included includes not only when the electronic device 300 does not include a display configuration, but also when the electronic device 300 includes a display that is difficult to display information that a new IoT has been detected from a user, or when the electronic device 300 has an interface structure that makes it difficult for the user to select whether to register, even if the information is displayed. The above describes only displaying the above-described notification in a display method, but in an implementation, the above-described notification may be performed as sound and the user's command may also be input by the user's voice.

When the electronic device 300 or other device receives an instruction to proceed with the registration for a new IoT device, the processor 330 may control the communication device 310 to transmit to the new IoT device information necessary for the new IoT device to connect to an IoT environment or Internet network in order to register the new IoT device.

Subsequently, the electronic device 300 may generate location information of the electronic device 300, and store the generated location information in the memory 320. Such location information may be generated using information directly entered by the user, or using information received from other devices.

For example, when the electronic device 300 is an IoT device such as a refrigerator, the location information set by the user during the registration process with the IoT system may be stored in the memory 320. When the electronic device 300 is a terminal device such as a mobile smartphone, the electronic device 300 may receive a current location from the user, or may measure the signal strength with other pre-registered IoT devices and store the location information of other IoT device with the largest signal strength as the location information of the electronic device 100.

Subsequently, the electronic device 300 may generate reference information for each of a plurality of locations, or may update the generated reference information. For example, when the electronic device is a user terminal device and initially establishes an IoT environment for a particular space, the electronic device 300 may receive information such as a type, size, etc., of the corresponding living space, or may receive address information, etc. of the corresponding living space to generate reference information about a plurality of spaces constituting the corresponding living space and between the plurality of spaces. Such reference information may be generated based on data for each size of the living space pre-generated by the manufacturing device, or actual measurement values from other environments having the same living environment may be used.

In addition, when there are a plurality of IoT devices in an IoT system, the electronic device 300 may update the reference information described above based on the signal values measured between the IoT devices described above. In addition, when the electronic device 300 is a user terminal device, the electronic device 300 may update the reference information through the process of providing guidance information for positioning the user and a specific IoT device in a specific space and actually measuring the signal strength between each space.

When the electronic device 300 is a robot cleaner, it is also possible to update the reference information described above by generating a map corresponding to the user's space, moving to one of the spaces on each map, and measuring signal strength with respect to other IoT devices located in other spaces in the corresponding space.

As described above, the electronic device 300 according to an embodiment may predict the location of an unregistered IoT device and considers the signal strength by taking into account the current location of the electronic device and the predicted location of the IoT device, so it is possible to identify whether the corresponding IoT device is an available device to the user more accurately. In addition, since the above-described comparison operation is performed in the background without any separate user manipulation, the user can a new IoT device only with a minimum operation during the process of registering the new IoT device.

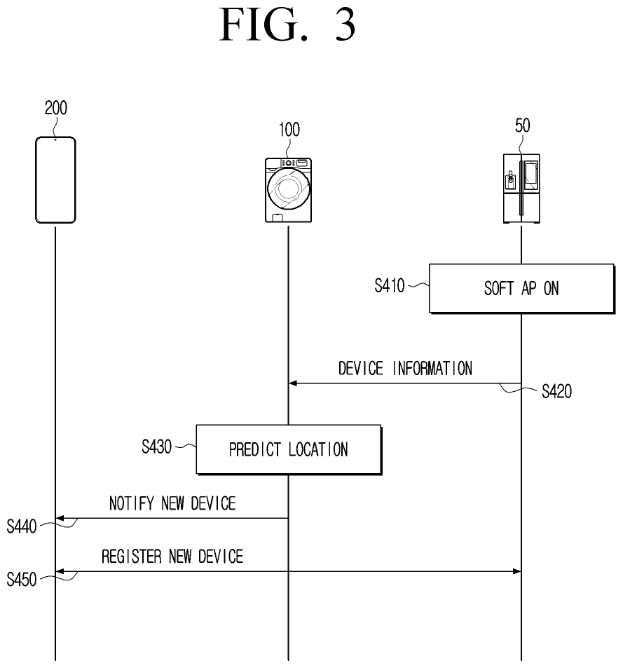

Although FIG. 3 shows and describes that only a basic configuration of the electronic device 300 (the communication device 310, the memory 320, and the processor 330) is included, the electronic device 300 may further include other configurations in addition to those described above, which are necessary to perform the functions of the electronic device. For example, when the electronic device 300 is a refrigerator, other configurations related to built-in functions may be further included, when the electronic device 300 is a washing machine, other configurations related to washing machine functions may be further included, and when the electronic device 300 is a CCTV, other configurations related to camera functions, etc. may be further included.

FIG. 3 is a sequence view provided to explain a registration process of a new electronic device according to an embodiment.

FIG. 3 illustrates the registration process for a new electronic device, assuming that the new IoT device 50 is located (or installed) in an environment where two pre-registered IoT devices—IoT device 100, IoT device 200—are located.

When the new IoT device 50 is not registered with an IoT server or the like, the new IoT device 50 may turn on a Soft AP, and transmit a beacon to a neighboring device (S410). When the communication method of the new IoT device 50 is BLE, the new IoT device 50 may broadcast a beacon including information that it is not onboarded. Alternatively, when the communication method of the new IoT device 50 is a P2P communication method other than the communication method described above, the new IoT device 50 may transmit a beacon to a neighboring device using the corresponding P2P communication method.

A first IoT device 100 may periodically search for the presence of a new IoT device, and when the new IoT device 50 is identified during the search process, the first IoT device 100 may receive device information from the new IoT device (S420).

The receiving of the beacon and the receiving of the device information have been described separately, but in an implementation, the receiving of the beacon and the receiving of the device information may be performed as a single operation. In the case where the receiving of the beacon and the receiving of the device information are separated, the first IoT device 100 may perform P2P communication with the new IoT device 50 to receive the device information of the new IoT device 50, and may identify the signal strength information with respect to the new IoT device 50. In the illustrated example, the new IoT device supports a WiFi method to perform communication using the Soft AP method of the WiFi communication module, but BLE or other P2P methods may also be used.

The first IoT device 100 may predict the location where the new IoT device will be located based on the device information (S430), confirm a signal strength reference value corresponding to the predicted location and the location of the first IoT device 100, and identify whether the new IoT device is an available device to the user by comparing the confirmed signal strength reference value and the actual measured signal strength value. Here, the expression of identifying whether a new IoT device is an available IoT device may be expressed as identifying whether a new IoT device is located in an installation space where an IoT device is installed, or may also be expressed as identifying whether a new IoT device is a new IoT device installed by a user (or an installer).

As such, when it is identified that a new IoT device is an available IoT device, a user confirmation operation may be performed to register the new IoT device. For example, when the current electronic device 300 is a device including a display, the electronic device 300 may directly indicate that a new IoT device has been detected and proceed with the registration process. A device not including a display includes a case where the device does not include a display, or a case where the device includes a display but is unable to receive an IoT registration command from the user or notify the user that a new IoT device is present.

When the first IoT device 100 does not include a display, or when the registration process is set to be performed on a user terminal device, the first IoT device 100 may provide information that a new IoT device has been detected to another pre-registered device (e.g., the second IoT device 200) (S440).

Upon receiving the above information, the second IoT device 200 may display information that a new IoT device has been detected, and may receive confirmation from the user to proceed with registration. Upon receiving such confirmation, the second IoT device 200 may register the new IoT device 50 with the IoT system, and perform a setting operation to enable the corresponding IoT device 50 to connect to the Internet or the IoT system (S450).

Although it has been described that the second device performs the registration process according to an implementation, the second device may perform the user confirmation operation only, and the operation such as connecting the new IoT device to the IoT system may be performed by the first device.

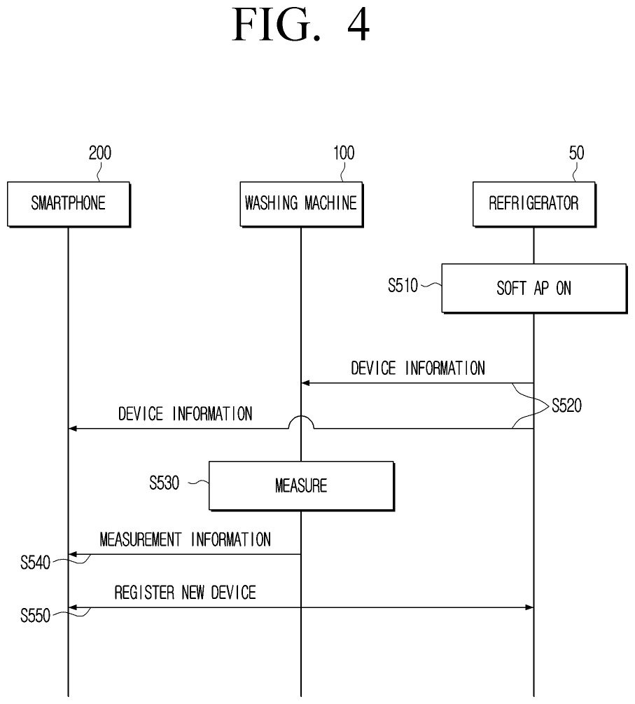

Although it has been described above that the operation of identifying whether a new IoT device is an available device is performed by the first IoT device, the operation may be performed by the second IoT device according to an implementation, which will be described below with reference to FIG. 4.

FIG. 4 is a sequence view provided to explain a registration process of a new electronic device according to an embodiment.

Referring to FIG. 4, when the new IoT device 50 is not registered with an IoT server or the like, the new IoT device 50 may turn on a Soft AP and transmit a beacon to a neighboring device (S510).

When such a beacon is detected by both the first electronic device and the second electronic device (S520), the first IoT device 100 may be provided with a measurement value for a signal between new IoT devices from the second IoT device 200 (S530, S540), and may identify whether it is an available device based on the measurement value and the transmitted device information.

When it is identified as an available IoT device, the registration process may be performed (S550).

In the example shown, it has been described that, assuming that the first IoT device is a smartphone, the signal strength received directly from the new IoT device is not measured, and only the second IoT device measures the signal strength, but in an implementation, the first IoT device may also directly measure the signal strength, and whether a new IoT device is an available IoT device may be identified using signal strength information measured by other registered IoT devices as well as the second IoT device.

When the corresponding IoT device is an available device, the same registration process as described above may be performed. Such a registration process may be performed by the first IoT device 100 directly, or by the second IoT device 200 in response to the command of the first IoT device 100.

When the user decides not to register the detected IoT device, device information (e.g., a do-not-register list) for the detected IoT device may be stored. If the first IoT device 100 stores the do-not-register list, when an unregistered IoT device is detected, the first IoT device 100 may check whether the unregistered IoT device is included in the do-not-register list, and if not, perform a notification operation for the registration process as described above, and if it is, terminate without any notification operation. Such a do-not-register list may be stored in only one device (e.g., the device that displays the notification), or it may be shared by all devices in the IoT system. The storage of the information described above may be carried out for a preset period of time, which may be a preset time or an arbitrary period of time selected at the discretion of the user.

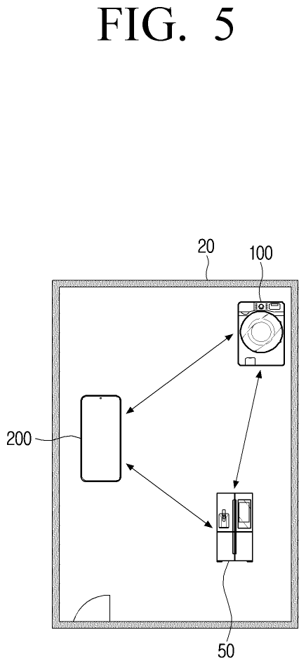

FIG. 5 is a view illustrating another application environment of the present disclosure. Specifically, FIG. 5 illustrates an example where a plurality of IoT devices are located in a single space 20 (e.g., a studio apartment).

A living space like a studio apartment is located very close to living spaces of other users, making it much more likely that the other users' IoT devices will be detected than environments such as a typical apartment.

For example, even an unregistered IoT device having a high signal strength, which can be identified as being located in the user space such as an apartment, is highly likely to be a device that the user has not installed.

Therefore, in order to identify whether a living space is a living space like a studio apartment, when a living environment is input from the user in advance, or when the signal strength between the pre-registered IoT devices is high, it is possible to identify that the user's living space is a living space such as a studio apartment. As such, by identifying the user's living environment and identifying whether an IoT device is available based on a reference signal value that fits the corresponding living environment or space, it is possible to identify with high accuracy whether a new IoT device is an IoT device installed by the user.

Such identification can be made during the process of identifying whether the new IoT device 50 needs to be registered, or alternatively, a lookup table can be created in advance to suit the current environment, and the identification can be made using the same process as previously described. An example of a lookup table that is adaptively created for the actual environment will be described below with reference to FIG. 6.

FIG. 6 is a view illustrating an example of a lookup table according to an embodiment.

Referring to FIG. 6, an embodiment of the present disclosure illustrates a lookup table with information about locations of two different devices and threshold values of signal strength for each location.

For example, when an IoT device, an electronic device, etc. are installed in a living environment consisting of a living room, a kitchen, a utility room, and a master bedroom, the corresponding lookup table may store information about a minimum threshold value in each of the above-mentioned spaces.

The lookup table described above may be created in various ways, one example of which will be described below.

In setting up an IoT environment, the user may first select a living environment (e.g., an apartment, a studio apartment, an office, etc.) and select a size of the living environment (e.g., square footage information). Once these selections are made, the above-described lookup table may be generated by receiving information about a signal strength threshold value of each of the corresponding spaces from a server. Although it has been described that the above-described lookup table is generated by selecting a living environment and a size according to an implementation, it is also possible to receive address information from the user, and receive the above-described lookup table from a server using information about the living environment and size corresponding to the received address information.

It is also possible that the information for each of the spaces described above is not received from an external server, but is input directly from the user. Further, the strength threshold value of each signal may be an initial value provided by the server, or may be modified based on the signal strength received from other pre-registered IoT devices.

For example, it may be assumed that a pre-registered IoT device is a washing machine, and the installation space of the corresponding washing machine is set to a utility room. In such an environment, when other IoT devices or user terminals are located in the master bedroom, the signal strength between the devices located in the master bedroom and the washing machine installed in the utility room can be measured, and the above-described strength threshold value may be updated by using the measured signal strength as an average value or a minimum value. As such, the lookup table may be updated using values measured in the actual environment, rather than using only information received from the initial server, so it is possible to identify whether a new IoT device is located in the corresponding space more accurately.

Although FIG. 6 describes and illustrates that the strength of a received signal is used as a signal value, but various signal values such as RSRP, RSRQ, etc. may be used in an implementation. In addition, not only lower limit values but also upper limit values and lower limit values together may be used as the threshold value. Further, in an implementation, it is possible to store the actual measured value (or an average value of the actual measured value, etc.), and add or subtract a certain value to and from the actual measured value to calculate the threshold upper limit value and the threshold lower limit value in the process of identifying whether a new IoT device is an available IoT device.

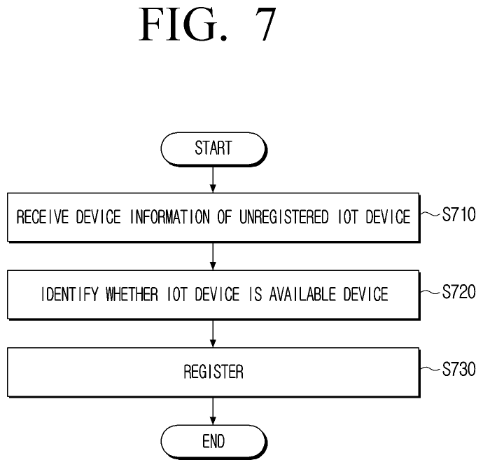

FIG. 7 is a flowchart provided to explain a control operation of an electronic device according to an embodiment.

Referring to FIG. 7, device information of an unregistered IoT device is received (S710). Specifically, the electronic device may periodically search for the presence of unregistered IoT devices, and receive device information from the detected unregistered IoT devices. Here, the device information may include information about the type of device (e.g., camera, washing machine, TV, etc.) regarding the corresponding device, and the strength of the signal transmitting the device information may be measured. Such measurement may use the signal transmitting the device information described above, or may use any signal other than the signal described above, as long as the signal is transmitted from an unregistered IoT device described above.

Whether an IoT device is an available IoT device is identified (S720). Specifically, the product type of the IoT device may be identified based on the received device information. As described above, the product type may be identified based on information included in the device information of the IoT device. When the device information does not include information to identify the product type, the electronic device may transmit other identification information included in the received device information to an external server, and use the product type identified and received from the external server.

Subsequently, based on the identified product type, the location of the IoT device may be predicted, and a signal strength reference value for the IoT device may be identified based on pre-stored reference information for each of a plurality of locations, the location of the electronic device, and the predicted location. For example, when the IoT device is a refrigerator, the location of the IoT device described above may be predicted to be a kitchen, since refrigerators are typically located in kitchens. When the location of the electronic device is the living room, the pre-stored lookup table may identify the signal reference value between the kitchen and the living room.

By comparing the identified signal strength reference value and the signal strength of the IoT device, it is identified whether the IoT device is an available IoT device. For example, when the signal strength of the IoT device is less than the identified signal strength threshold, the IoT device may be identified as an unavailable IoT device.

In an implementation, it is possible to use a plurality of reference values, i.e., a lower threshold reference value and an upper threshold reference value, rather than a single reference value. For example, when the signal strength of the IoT device is within the range of the upper threshold reference value and the lower threshold reference value, the IoT device may be identified as an available IoT device, and when the signal strength of the IoT device is greater than the upper threshold reference value or less than the lower threshold reference value, the IoT device may be identified as an unavailable IoT device.

An unregistered IoT device may be located in various locations, for example, a device such as a refrigerator may be located in a specific space such as a kitchen or a utility room, while a device such as an air purifier may be located in various spaces such as a master bedroom, a living room, etc. Therefore, for IoT devices that can be located in various spaces, an operation of comparing the predicted reference strength signal values for each of the plurality of locations with the signal strength of the IoT devices may be performed.

When an IoT device is an available IoT device, the IoT device is set as an available IoT device (S730). Specifically, the setting operation may be performed manually or automatically. For example, when it is set to register an unregistered device automatically, it is possible to set the corresponding IoT device as an available IoT device without user confirmation.

If user confirmation is required, when the current electronic device is a device including a display, the device may indicate that registration for the IoT device is available for user confirmation. When the current electronic device does not include a display, or when the user has set the notification setting to be displayed only on a specific device, information indicating that registration for an IoT device is available may be sent to at least one of a pre-registered IoT device or a registered user terminal device.

When the confirmation operation for such notification is completed by the user, the electronic device may transmit at least one of the information required to connect to the Internet or the information required to connect to the IoT server to the IoT device.

As described above, the controlling method according to an embodiment is capable of predicting the location of an unregistered IoT device and considering the signal strength by taking into account the location of the current electronic device and the predicted location of the IoT device, thereby identifying whether the IoT device is an available IoT device to the user more accurately. In addition, since the above-described comparison operation is performed in the background without any user manipulation, the user may register a new IoT device with a minimal operation even in the process of registering the new IoT device.

Terms “˜er/or” or “module” used in the disclosure may include units configured by hardware, software, or firmware, and may be used compatibly with terms such as, for example, logics, logic blocks, parts, circuits, or the like. The “˜er/or” or “module” may be an integrally configured part or a minimum unit performing one or more functions or a part thereof. For example, the module may be configured by an application-specific integrated circuit (ASIC).

Various embodiments according to the present may be implemented in software including an instruction stored in a machine-readable storage medium (e.g., computer). A machine may be a device that invokes the stored instruction from the storage medium and is operated based on the invoked instruction, and may include an electronic apparatus (e.g., electronic device 300) according to embodiments disclosed herein. In case that the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

According to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

The components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

What is claimed is:

1. An electronic device comprising:
a communication device;
memory storing location information of the electronic device and reference information associated with each of a plurality of locations; and
at least one processor configured to, based on device information of an unregistered Internet of Things (IoT) device being received through the communication device, set the IoT device as an available IoT device,
wherein the at least one processor is configured to set the IoT device as the available IoT device by:
identifying a product type of the IoT device based on the device information,
predicting a location of the IoT device based on the product type,
identifying a signal strength reference value associated with the IoT device based on the reference information associated with each of the plurality of locations, a location of the electronic device, and the location of the IoT device, and
identifying whether the IoT device is the available IoT device based on a comparison of the signal strength reference value associated with the IoT device with a signal strength of the IoT device.

2. The electronic device of claim 1, wherein the at least one processor is further configured to, based on the signal strength of the IoT device being less than the signal strength reference value associated with the IoT device, identify the IoT device as an unavailable IoT device.

3. The electronic device of claim 1, wherein the signal strength reference value associated with the IoT device comprises a lower threshold reference value and an upper threshold reference value; and
wherein the at least one processor is further configured to:
based on the signal strength of the IoT device being between the upper threshold reference value and the lower threshold reference value, identify the IoT device as the available IoT device, and
based on the signal strength of the IoT device being greater than the upper threshold reference value or less than the lower threshold reference value, identify the IoT device as an unavailable IoT device.

4. The electronic device of claim 1, wherein the at least one processor is further configured to:
predict a plurality of possible locations of the IoT device based on the product type, and
identify whether the IoT device is the available IoT device based on a comparison of a signal strength reference value corresponding to each of the plurality of locations with the signal strength of the IoT device.

5. The electronic device of claim 1, wherein the reference information associated with each of the plurality of locations stored in the memory is information generated based on a type of living space where the electronic device is located and a size of the living space.

6. The electronic device of claim 1, wherein the communication device is configured to identify the location of the electronic device based on a signal strength of a signal received from a pre-registered IoT device, and to store the location of the electronic device in the memory.

7. The electronic device of claim 1, further comprising:
a display,
wherein the at least one processor is further configured to, based on the IoT device being the available IoT device, control the display to display that setting registration of the IoT device is possible.

8. The electronic device of claim 1, wherein the at least one processor is further configured to, based on the IoT device being the available IoT device, control the communication device to transmit information indicating that setting registration of the IoT device is possible to at least one of a pre-registered IoT device or a pre-registered user terminal device.

9. The electronic device of claim 1, wherein the at least one processor is further configured to, based on the IoT device being set as the available IoT device, control the communication device to transmit to the IoT device at least one of information required for connecting to Internet or information required for connecting to an IoT server.

10. The device of claim 1, wherein the at least one processor is further configured to, based on receiving, from each pre-registered IoT device, information about respective signal strength between other IoT devices measured by the pre-registered IoT device, update the reference information associated with each of the plurality of locations in accordance with the received information about the respective signal strength and location information of the pre-registered IoT device.

11. A controlling method of an electronic device, the method comprising:
receiving device information of an unregistered IoT device;
identifying whether the Internet of Things (IoT) device is an available IoT device; and
based on the IoT device being the available IoT device, setting the IoT device as the available IoT device,
wherein the identifying whether the IoT device is the available IoT device comprises:
identifying a product type of the IoT device based on the device information;
predicting a location of the IoT device based on the product type;
identifying a signal strength reference value associated with the IoT device based on pre-stored reference information associated with each of a plurality of locations, a location of the electronic device and the location of the IoT device; and
identifying whether the IoT device is the available IoT device based on a comparison of the signal strength reference value associated with the IoT device with a signal strength of the IoT device.

12. The method of claim 11, wherein the identifying whether the IoT device is the available IoT device comprises, based on the signal strength of the IoT device being less than the signal strength reference value associated with the IoT device, identify the IoT device as an unavailable IoT device.

13. The method of claim 11, wherein the signal strength reference value associated with the IoT device comprises a lower threshold reference value and an upper threshold reference value; and
wherein the identifying whether the IoT device is the available IoT device comprises:
based on the signal strength of the IoT device being between the upper threshold reference value and the lower threshold reference value, identifying the IoT device as the available IoT device, and
based on the signal strength of the IoT device being greater than the upper threshold reference value or less than the lower threshold reference value, identifying the IoT device as an unavailable IoT device.

14. The method of claim 11, wherein the predicting the location of the IoT device comprises predicting a plurality of possible locations of the IoT device based on the product type; and
wherein the identifying whether the IoT device is the available IoT device further comprises identifying whether the IoT device is the available IoT device based on a comparison of a signal strength reference value corresponding to each of the plurality of locations with the signal strength of the IoT device.

15. The method of claim 11, further comprising:
receiving, from each pre-registered IoT device, information about respective signal strength between other IoT devices measured by the pre-registered IoT device; and
updating the reference information associated with each of the plurality of locations based on the received information about the respective signal strength and location information of the pre-registered IoT device.
